(19) United States
(12) Patent Application Publication
(10) Pub. No.: US 2012/0094261 A1
(43) Pub. Date: Apr. 19, 2012

(54) Flow Meter for a Container and Method for Monitoring the Hydration of a Patient

(75) Inventors: Henning Hayn, Stuttgart (DE); Gabor Conrad, Renningen (DE)

(73) Assignee: Robert Bosch GmbH, Stuttgart (DE)

(21) Appl. No.: 13/237,700

(22) Filed: Sep. 20, 2011

(30) Foreign Application Priority Data
Sep. 21, 2010 (DE) 10 2010 041 112.4

(51) Int. Cl. G09B 19/00; G01F 1/44; G01F 1/78; G01F 1/68; F16K 21/04; G01F 1/00

(52) U.S. Cl. 434/247; 137/511; 73/861; 73/861.354; 356/27; 73/204.11; 73/861.63

(57) ABSTRACT

A flow meter for a container, for monitoring the dehydration of a patient, has a sensor unit for detecting a flow through the flow meter and a control unit for recording an amount of liquid passing through during a time interval. The flow meter is an adapter for connection to a bottle or a beaker. A patient receives a warning if he should take in liquid. A base station serves for bidirectional transmission of measurement data to an external apparatus, more particularly a telemedical center.

This application claims priority under 35 U.S.C. §119 to German patent application no. DE 10 2010 041 112.4, filed Sep. 21, 2010 in Germany, the disclosure of which is incorporated herein by reference in its entirety.

### BACKGROUND

The present disclosure relates to a flow meter for a container and a method for monitoring the dehydration of a patient.

Diet plays an important role, particularly in the case of chronically ill patients, e.g. who suffer from diabetes, obesity or cardiovascular disorders. In nutritional terms, it is not only the intake of solid food but also the intake of liquid food that is relevant. The water balance has an important influence on the health of the patient. Many patients are only able to describe their drinking habits subjectively and cannot determine the precise amount that they drink. They often drink too little and even forget to take in the required amounts of liquid. The lack of water slows down the metabolism and causes headaches. Nutrients, vitamins and enzymes are no longer transported correctly. Moreover, a lack of water causes daytime tiredness and exhaustion. Lack of water moreover increases the risk of suffering a stroke. WO 2000043061 presents a device and a method for dispensing liquids, wherein a patient is monitored for dehydration by having a pump deliver liquid from a container and by determining the amount of liquid delivered. US 20060231109 discloses a bottle for medicating a user with a substance, wherein the bottle has a sensor for determining an attribute of the user. The bottle can record the drinking habit of the user and the amount of substance taken in via the weight of the bottle.

### SUMMARY

By contrast, the flow meter for a container for monitoring the dehydration of a patient in accordance with the present disclosure is advantageous in that it allows simple monitoring of the drinking habit of a human. The flow meter can measure the amount the patient drinks over the course of a day. The meter can be embodied as an attachment for drinks bottles or for drinking vessels. The amount of liquid is measured by a sensor when drinking directly from the bottle or during pouring.

The flow meter as per one embodiment of the present disclosure is advantageous in that it reminds the patient should he have to drink more. An advantage of a further embodiment of the present disclosure is that the flow meter can transmit the measured data to a telemedical center via a telemedical system (server). As a result, data is transmitted in respect of both the liquid balance and the compliance of the patient (the “cooperation of the patient”) to a telemedical center and hence to the treating medical staff, who are skilled in the art. The regular reminders by the system and also the monitoring of the drinking habit increase the certainty that the patient takes in sufficient amounts of liquid.

### BRIEF DESCRIPTION OF THE DRAWINGS

Exemplary embodiments of the disclosure are explained on the basis of the drawings, in which:

FIG. 1 shows a schematic illustration of a bottle with a flow meter as per an embodiment of the present disclosure;

FIG. 2 shows a lateral view of a beaker with a flow meter as per an embodiment of the present disclosure;

FIG. 3 shows a schematic illustration of a base station as per an embodiment of the present disclosure;

FIG. 4 shows a flowchart of the method as per an embodiment of the present disclosure; and

FIG. 5 shows a flowchart of the method as per a further embodiment of the present disclosure.

### DETAILED DESCRIPTION

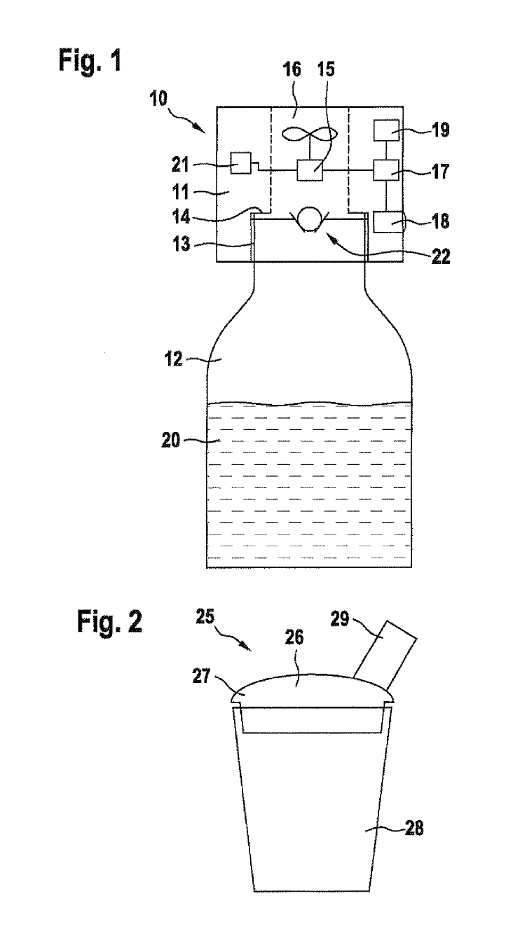

FIG. 1 illustrates a flow meter 10 as per an embodiment of the present disclosure as an attachment 11 on a bottle 12. The attachment 11 has a thread 13 and a stop 14 for being screwed onto the bottle 12. Alternatively, there can be an embodiment of a clamp connection or a plug-in connection for the connection to a bottle. The flow meter 10 has a sensor unit 15, for measuring an amount of liquid that flows through a channel 16 in the flow meter 10, and a control unit 17 connected to the sensor unit. The flow meter 10 furthermore has an interface 18, connected to the control unit 17, for data interchange with a base station, and an energy supply unit 19, likewise connected to the control unit 17. The energy supply unit 19 is preferably a battery or a rechargeable battery; alternatively use can be made of a power harvesting element.

The sensor unit 15 detects liquid 20 passing through, more precisely a flow rate through the flow meter 10, and the control unit 17 records an amount of liquid passed through during a short time interval by integrating the flow rate over the time interval. The control unit 17 comprises a clock. An amount of liquid taken in by a patient over a relatively long period is determined by adding the amount of liquid taken in during the time intervals of the period, with the assumption being made that the patient takes in the entire amount of liquid that has passed through the flow meter 10. Thus a patient is monitored for dehydration over the period. The flow meter 10 has an apparatus 21 for signaling that a user has taken in too little liquid over the period. The signaling can be brought about by optical, acoustic or haptic means.

The flow meter 10 has a check valve 22 with a ball, which is closed when the bottle is in the upright position. The sensor unit 15 has a sensor from the set consisting of turbine flow meter, Woltmann meter, small “propeller”, Coriolis mass flow meter, optical flow meter, ultrasound flow meter, calorimetric flow meter and Venturi meter.

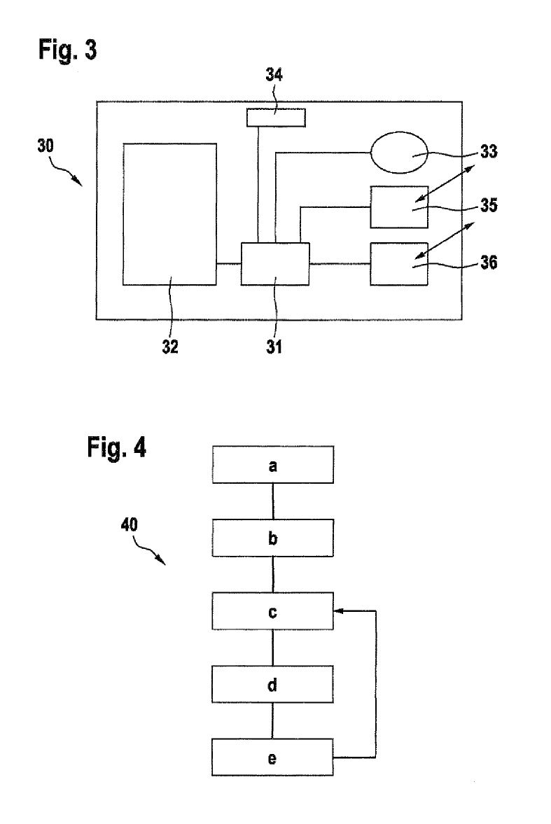

The flow meter 10 from FIG. 1 is equipped with the interface 18 for data interchange with a base station. Such a base station is described in conjunction with FIG. 3. Alternatively, an embodiment without base station is possible; instead, it then has a human-machine interface (HMI), e.g. an input element and a display. If the instrument does not have an HMI, use is made of the HMI of the base station.

FIG. 2 shows a drinking vessel 25 with a flow meter 26 as per an embodiment of the present disclosure as a sippy cup. The flow meter 26 is shaped as an adapter 27 for connection to a beaker 28, and has a pouring opening 29 designed such that it is possible to drink directly therefrom.

FIG. 3 shows a base station 30 for a flow meter as per an embodiment of the present disclosure. The base station 30 has a control apparatus 31, a touchscreen display 32 connected thereto and a signaling element 33, which in this case is in the form of an LED; however, alternatively other optical elements and/or a loudspeaker are also possible. The touchscreen display 32 and the signaling element 33 form a human-machine interface. In addition to a current-supply unit 34 connected to the control apparatus 31, the base station 30 has a radio interface 35, likewise connected to the control apparatus 31, for data interchange with the flow meter 10 from FIG. 1 and an interface 36, likewise connected to the control apparatus 31, for data interchange with an external apparatus, more particularly a server.

The base station can be embodied as a base station of a telemedical system. A telemedical system consists of a plurality of peripheral instruments, e.g. blood-pressure collar, blood-glucose measurement instrument, SpO2 measurement instrument, which transmit measurement data from a patient to a base station, e.g. a “Health Buddy”, via wired connection, Bluetooth or infrared. The base station forwards this measurement data to a server via a telephone or Internet connection. It is stored in an electronic patient file. The latter can be seen and evaluated by medical practitioners and medical staff skilled in the art. The software on the server including Web-interface for the medical staff skilled in the art is referred to as a telemedicine platform (TMP). The data stored on the server or on the TMP can be accessed from a telemedical center (TMC). As a result of monitoring the patient at home, telemedical systems can make a contribution to increasing the effectiveness of medical care and hence can lower costs. The recorded measurement values can be transmitted to a telemedical center via the base station by means of interface 36. Conversely, it is also possible to transmit values, e.g. the prescribed amount of liquid, from the TMP to the flow meter via the base station. The involved interfaces may operate in a bidirectional fashion. Hence, the flow meter can be set individually for the patient from a TMC.

With the control unit 31, the base station 30 has an apparatus for monitoring an amount of liquid that flowed through the flow meter 10 over a period and can use the signaling element 33 to signal that a user has taken in too little liquid over the period. The calculation of the liquid taken in by the user over a relatively long period is also performed in the base station.

The base station 30 has an apparatus for distinguishing between a plurality of users. This task is assumed by the control unit 31. Different users can advantageously each obtain an assigned vessel with a flow meter. The assignment and administration of vessels and users is performed via the touchscreen display 32 of the base station 30. A vessel can advantageously have a flow blockage in a flow meter, which is only lifted after identifying or assigning a user. Use of the same bottle by a plurality of users is possible but more complicated, with each removal then having to be assigned to a user.

The disclosure provides a measurement instrument for establishing the amount of liquid that a human takes in. Various embodiments are possible in the process. The measurement instrument consists of e.g. an attachment for drinks bottles (as shown in FIG. 1) or an attachment for drinking vessels (as shown in FIG. 2). The amount of liquid is measured by a sensor when drinking directly from the bottle or during pouring. In one variant, the device can be designed such that it surrounds the bottle neck and the bottle opening can be used for drinking/pouring, whilst using contactless measurement methods. In a second variant the device is inserted into the bottle neck. As before, use is made of the bottle opening for pouring. In a third variant, the device is placed on the bottle opening. The device has an opening through which the liquid flows during pouring. The opening can be shaped such that it is possible to drink directly from the opening.

The opening of the measurement instrument is automatically sealed by a check valve 22, e.g. a ball check valve, actuated by gravity when the bottle is put down. As an alternative to this, the bottle can also be sealed by a screw top. In a multi-person household it is necessary to identify which person is drinking. To this end, a sensor for biometric features may be integrated into the measurement instrument. As an alternative to this, every person wishing to drink from the bottle could identify themselves via an operating element, for example by entering their name, pressing buttons or pressing on icons. In one variant, the measurement instrument can block the outlet valve if the user has not identified himself prior to drinking. In one variant, the bottle is a conventional drinks bottle. The measurement instrument fits on the conventional bottle sizes or openings and screw tops. In another variant, the measurement instrument only fits on a specific bottle, which is delivered with the system. In this case it must be possible to refill the bottle; optionally it must be possible to deactivate the check valve. The system could be dimensioned to be compatible with mineral water dispensers. As a result it would be possible to add different flavors and carbon dioxide to the water. It should be possible for the patient to clean the device himself and said device should be suitable for dishwashers.

The interaction between flow meter and base station can accordingly have varied embodiments. The data as to whether a person has drunk enough during the course of the day is evaluated either in the measurement instrument itself, in the base station, or on the TMP (server) or by the medical staff skilled in the art. The software sends an answer to the patient. If a sufficient amount of liquid was taken in, there is a positive or no response. As soon as the amount taken in is too low, the patient is reminded that he has to drink more. This can be brought about on a display or acoustically: “Please drink another 0.7 liters today”. The response can appear on the display of the base station or of the flow meter, or via another instrument, e.g. telephone, mobile terminal, TV or clock. The instruments can remind the patient optically, haptically or acoustically to drink. An advantage of the flow meter is that the patient is always informed as to whether he has to drink more or not. The treating staff, who are skilled in the art, are also informed in respect thereof. The data can be stored in the electronic patient file.

A bottle with flow meter can, for use outside a home, be embodied with input means, displays and powerful control unit such that a use without base station is possible. In a home the use of a base station is advantageous because a base station can provide a more comfortable, larger HMI and a flow meter with fewer functions has a smaller design.

FIG. 4 shows a flowchart 40 of the method as per one embodiment of the present disclosure. The method for monitoring the dehydration of a patient using a flow meter starts with the following method step:

a) entering an amount of liquid that a patient should take in over an observation period. The observation period advantageously is 1 day as a standard observation period. Then there is no need to specifically specify the period. This is followed by the method step of:
b) starting a period. The period from the start to the current time serves as a basis for calculating the amount of liquid that should have been taken in to date. The clock of the control unit 17 is reset. This is now followed repeatedly by the method step of:
c) measuring a current amount of liquid that a patient is currently taking in; and the method step of:
d) adding the current amounts of liquid to an overall amount of liquid that a patient has taken in over the period since the start. In the method step:
e) the overall amount of liquid is displayed. Subsequently there is a loop back to method step c) in order to record more liquid being removed.

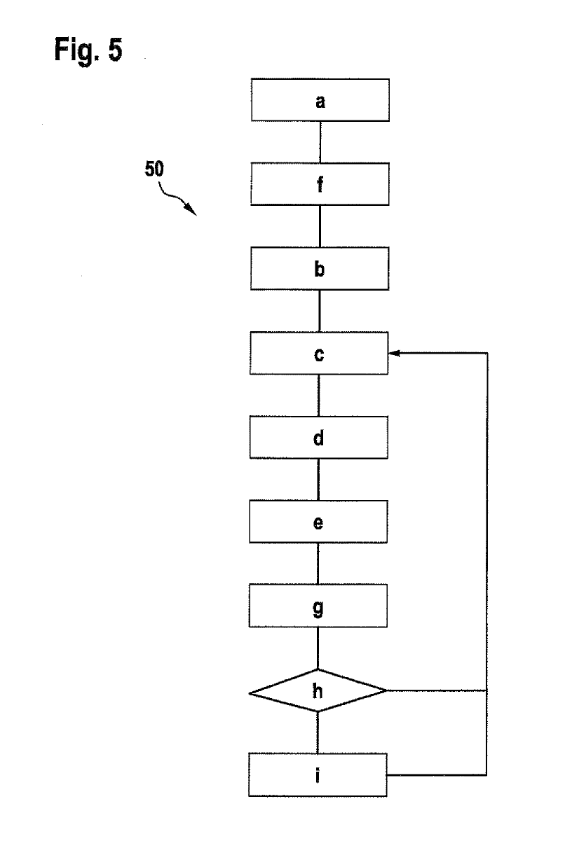

FIG. 5 shows flowchart 50 of the method as per a further embodiment of the present disclosure. The method steps a) to e) are the same as those from flowchart 40 in FIG. 4, but now there are additional method steps. The method once again starts with the method step of:

a) entering an amount of liquid that a patient should take in over an observation period. However, this is now followed by
f) entering a time profile for the amount of liquid that the patient should take in over a period. This option allows a deviation from a regular liquid uptake and is advantageous when controlled by a TMC. Next there are the method steps known from flowchart 40 in FIG. 4:
b) starting a period;
c) measuring a current amount of liquid that a patient is currently taking in;
d) adding the current amounts of liquid to an overall amount of liquid that a patient has taken in over the period since the start; and
e) displaying the overall amount of liquid.
Now, unlike flowchart 40 in FIG. 4, this is followed by the method step of:
g) determining the amount of liquid that the patient should take in over the period since the start. In the case of an optional TMP connection, the established amount of liquid, advantageously with the time of the measurement, is transmitted to the TMP in this method step for storage and further evaluation. Optionally there is only a report if liquid was actually taken up. This is followed by the method step of:
h) checking whether the amount of liquid that the patient has taken in over the period since the start corresponds at least to the amount of liquid that the patient should take in over the period.
If the amount of liquid that the patient has taken in over the period since the start is less than the amount of liquid that the patient should take in over the period, there is the method step of:
i) emitting a warning that the patient should take in liquid, and in turn there is a loop back to method step c) in order to record more liquid being removed. In the case of a TMP connection, the method steps h) and 1) can take place on the TMP as an alternative, or in addition, to taking place in the base station or in the flow meter, and the TMP can initiate the warning or an additional warning, optionally via different channels, e.g. a call or an SMS. If the amount of liquid that the patient has taken in over the period since the start is no less than the amount of liquid that the patient should take in over the period, method step h) is followed directly by a loop back to method step c) in order to record more liquid being removed.

What is claimed is:

1. A flow meter for a container, for monitoring the dehydration of a patient, comprising:
a sensor unit configured to detect a flow through the flow meter; and
a control unit configured to record an amount of liquid passing through during a time interval.

2. The flow meter according to claim 1, further comprising an adapter for connection to a bottle or a beaker.

3. The flow meter according to claim 1, further comprising a pouring opening designed such that it is possible to drink directly therefrom.

4. The flow meter according to claim 1, further comprising a check valve.

5. The flow meter according to claim 1, wherein the sensor unit has a sensor selected from the following group: a turbine flow meter, a Woltmann meter, a Coriolis mass flow meter, an optical flow meter, an ultrasound flow meter, a calorimetric flow meter and a Venturi meter.

6. The flow meter according to claim 1, wherein the control unit is designed to monitor an amount of liquid passing through over a period and the flow meter has an apparatus for signaling that a user has taken in too little liquid over the period.

7. An assembly, comprising:
a flow meter for a container, for monitoring the dehydration of a patient, including (i) a sensor unit configured to detect a flow through the flow meter, and (ii) a control unit configured to record an amount of liquid passing through during a time interval; and
a base including an apparatus configured to receive measurement data from the flow meter.

8. The assembly according to claim 7, wherein the base station is configured to monitor an amount of liquid passing through over a period and has an apparatus for signaling that a user has taken in too little liquid over the period.

9. The assembly according to claim 7, wherein the base station has a human-machine interface.

10. The assembly according to claim 7, further comprising an apparatus configured to distinguish between a plurality of users.

11. The assembly according to claim 10, wherein the apparatus configured to distinguish between the plurality of users is configured to generate, as a result of identifying a user, a signal for lifting a flow blockage in the flow meter.

12. The assembly according to claim 7, further comprising an apparatus configured to transmit measurement data to an external apparatus.

13. A method for monitoring the dehydration of a patient using a flow meter, comprising:
a) entering an amount of liquid that a patient should take in over an observation period;
b) starting a period;
c) measuring a current amount of liquid that a patient is currently taking in;
d) adding the current amounts of liquid to an overall amount of liquid that a patient has taken in over the period since the start; and
e) displaying the overall amount of liquid.

14. The method according to claim 13, further comprising:
f) entering a time profile for the amount of liquid that a patient should take in over a period.

15. The method according to claim 14, further comprising:
g) determining the amount of liquid that the patient should take in over the period since the start;
h) checking whether the amount of liquid that the patient has taken in over the period since the start corresponds at least to the amount of liquid that the patient should take in over the period; and
if the amount of liquid that the patient has taken in over the period since the start is less than the amount of liquid that the patient should take in over the period:
i) emitting a warning that the patient should take in liquid.

16. The assembly according to claim 12, wherein the apparatus configured to transmit measurement data to the external apparatus includes a telemedical system.
